(19) United States
(12) Patent Application Publication
(10) Pub. No.: US 2005/0251552 A1
(43) Pub. Date: Nov. 10, 2005

(54) Address generation method in a device connected to a network and device employing said method

(76) Inventors: Mary-Luc Champel, Marpire (FR); Jean-Francois Fleury, Rennes (FR); Gilles Straub, Marpire (FR)

Correspondence Address: THOMSON LICENSING INC., PATENT OPERATIONS, PO BOX 5312, PRINCETON, NJ, 08543-5312, US

(21) Appl. No.: 10/519,588

(22) PCT Filed: Jun. 25, 2003
(86) PCT No.: PCT/EP03/50259

§ 371 Date: Dec. 28, 2004

(30) Foreign Application Priority Data
Jun. 28, 2002 (FR) 0208087

(51) Int. Cl. G06F 15/16; G06F 15/173

(52) U.S. Cl. 709/204; 709/238

(57) ABSTRACT

The invention consists in a procedure for generating an address value within a terminal linked to a communication network. Initially, the terminal receives a pair of address values sent by a configured terminal. Then, the terminal determines a characteristic value of the network which is contained in the first and the second address values. The terminal then calculates a third address value containing the characteristic value of the network. Finally, the terminal assigns the third address value to the terminal if this value is not already assigned to another terminal. According to a refinement, the terminal sends a request to a terminal having this third request; if there is no response, this third address value does not belong to another terminal, so it can be assigned to the terminal to be configured. The invention also relates to the terminal designed to implement the procedure. The invention also relates to a terminal which receives a message comprising a first and a second address values. It is assigned the second address value if it turns out that the latter is not assigned to any other terminal of the network.

The present invention relates to a procedure for generating addresses in a device linked to a network and a device using this procedure.

These days, there are many different types of networks. Some are vast, enabling millions of terminals to intercommunicate, as is the case with the INTERNET. Others are much smaller, with just a few dozen devices, a few hundred at most. The latter networks are used in homes, to form domestic networks, and others are used in vehicles. To be able to communicate, the terminals have an address that is specific to them and that is known to the other terminals in the network. Some networks are equipped with intelligent devices which totally control data transmissions over the network (routers, etc.). When a message arrives within the network, this device, knowing the address of the recipient terminal, sends the message direct to that terminal. Other networks do not have such devices and each terminal receives all the messages interchanged and recognizes only the messages with a recipient address corresponding to its own. These examples show the importance of the address because it enables each terminal to be identified, to send messages and to receive them.

Communication within a network is performed through layers specified in the OSI (Open System Interconnection) model, in which layers 1 and 2 relate to the PHYSICAL and LINK levels, and layers 3 to 7 the logical levels. Two examples of layer 2 standards are ETHERNET II and IEEE802.3. Layer 3 relates to the NETWORK level which specifies the type of protocol used. A very widely used protocol, well suited to domestic networks, is the Internet Protocol (IP).

On an ETHERNET type network (based on an ETHERNET II or IEEE802.3 layer 2 protocol), each terminal has a physical address, MAC, which is defined by the manufacturer and permanently stored in the electronic circuit board. This address is located at the LINK level. In theory, it is not possible for two devices to have identical MAC addresses. In practice, each manufacturer has a block of addresses for generating the MAC addresses according to their requirements. The solution, if such a conflict exists, is to change the electronic circuit board in the device, but there is no program-based remedy. When a new device is connected to a network, it is important to assign it an address specific to the network, in other words the IP address, and this corresponds to the NETWORK level (layer 3). This address has a field which identifies the network and, to ensure that this address does not already belong to another terminal, it has a second field which identifies the terminal in the network. If the network has a configuration server (for example a Dynamic Host Configuration Protocol (DHCP) server), the latter can automatically assign addresses to any new device connected to the network. The configuration server ensures that a specific address value is assigned to each terminal. For smaller networks, typically domestic networks, the owner of the network manages his own addresses, and manually assigns a new address to the device he wants to install.

The addresses are encoded differently according to the size of the network. There are three main classes of network, identified A, B, and C. The terminals belonging to class A networks have within that network an address encoded on three bytes, the network identifier being encoded on one byte. The class B and C networks are increasingly smaller, but, conversely, there are increasingly more of them. It is easy to imagine that in the near future each home will have its own network, and because of this the identifiers of such class C networks are encoded on three bytes and the address of the terminal is encoded on one byte.

A network can be subdivided into a number of subnetworks, which enables a small number of terminals to be grouped together and their calls to be managed from a central server. If a terminal wants to communicate with another that is not on the same subnetwork, it sends the message to an intermediate server (called a Gateway) which retransmits the message to the recipient. In the case of an IP network, the address of the terminal includes a field containing the subnetwork identifier concatenated with the address value of the terminal which occupies the least significant bits (LSB). Before each call, the terminal sending the message must check whether the recipient belongs to the subnetwork.

The manufacturers of connectable devices often assign an IP address to the devices in the factory. When a device is bought and installed in a local area network, the IP address value given by the manufacturer is often inappropriate because the local area network does not necessarily use the same addressing plan, or the address is already used. Depending on the methods of configuring the device, it may be necessary to connect this device to a second network using the same addressing plan and in which the address is available, reconfigure its address and return the device to the first network. Another method consists in manually reconfiguring the address of the device, but this requires a good knowledge of the device and the method for reprogramming it. This method is tedious for the user.

The document EP 1 202 493 describes a procedure for configuring the address of an unconfigured terminal from a configured terminal. Following a request from the unconfigured terminal, the configured terminal sends it own address and the network mask. On receiving this data, the unconfigured terminal deduces from it another address value having the same network mask, tests to see whether this address is available, and, if it is, configures itself with the latter. The unconfigured terminal must therefore send a request for a message to be returned to it comprising an address and a network mask. This solution obliges the user to initiate a request over the network which means that it must already be configured to a minimum level and, in any case, this solution requires prior intervention from the user.

The document U.S. Pat. No. 5,854,901 describes a procedure for configuring the address of an unconfigured terminal by a configured terminal. The unconfigured terminal scans the network and captures calls containing an address value. It then tries by adding a unit to the captured address value and sending a call request to the terminal having that address. If there is no response, the address is available and it is assigned the address. If there is no response, this can mean that the captured address is the last address on the network and therefore the next value corresponds to an address that is no longer within the network. Because of this, the terminal may consider that its address is correct although it does not correspond to the network. Therefore, the procedure described in this document does not work in all cases.

The object of the present invention overcomes the problems described above and relates to a simple procedure for automatically assigning an address to a new device in a network.

The object of the present invention consists in a procedure for generating an address value for a communication terminal linked to a network, the procedure being characterized in that it comprises the following steps, at terminal level:

a) reception of a pair of first and second address values from at least one call captured on the network,

b) determination of a characteristic value of the network, said value being contained in the first and the second address values,

c) calculation of a third address value containing the characteristic value of the network,

d) assignment of the third address value to the terminal if this value is not already assigned to another terminal.

In this way, the terminal to be connected deduces from two address values received from the network, a characteristic value of the network and calculates a possible address which contains this characteristic value. It is therefore sure that the possible address can belong to this network. Then, the terminal tests whether this possible value is indeed available, in other words, that it is not already assigned to a terminal already configured. If this address value is not already assigned to a terminal of the network, it is automatically assigned to the terminal to be configured. Address generation is automatic and uses neither a manual generation procedure nor the services of a configuration server. By capturing a message including two address values, the terminal to be configured can deduce a part of the network mask and so generate a third address value which has every chance of being compatible with the network.

According to a refinement, when the network for the time being contains only a single terminal configured with a first address value, this terminal sends a message containing its address and a second address value calculated by changing the value of one bit. The terminal to be configured captures the message and, observing that no response is sent in return, which indicates that no terminal is assigned the second address, is assigned that second address value as its address value. The bit for which the value is changed is typically the least significant bit.

According to another refinement, the terminal to be configured receives two address values from two terminals already configured in the network, and deduces from them a characteristic value of the network. The terminal to be configured then calculates a third address value by concatenating this characteristic value and a specific value, beginning with the maximum value. If this third address value is not available, the terminal to be configured reduces the specific value by one unit while keeping the characteristic value of the network the same, and so on, in descending order of values until the terminal finds an available address value.

According to another refinement, if the terminal does not find an available address value, it calculates a third address value by changing the value of the least significant bit of the previously calculated characteristic value of the network, the characteristic value of the network being because of this reduced by one bit. Then, the terminal tests whether at least one of the new third calculated values is available. This procedure is iterative: each time the last characteristic value of the network is reduced by the least significant bit.

According to another refinement, the procedure comprises a step for sending an ARP call request by specifying the third address and a step for awaiting receipt of a response to said request. If a response is received, then the address contained in the request is already taken, the calculation of a new address is then performed and its availability is tested. Thus, the user does not have to intervene, the terminal to be configured automatically tests whether the new address that it has calculated is indeed available.

The object of the present invention also consists in producing an electronic device designed to be connected to a communication network, comprising a bidirectional means of communication with said network, characterized in that it comprises a means of receiving a message comprising a first and a second address value, a means for determining a characteristic value of the network which constitutes a part of the first and the second address values, and for calculating a third address value containing the characteristic value of the network, and for assigning this third address value to the device if, after a call request sent by the communication means to a device having the third address, it turns out that this third address value is not assigned to any terminal in the network.

The object of the present invention also consists in producing an electronic device designed to be connected to a communication network comprising a bidirectional means of communication with said network, characterized in that it comprises a means of receiving a message comprising a first and a second address values, and a means for assigning the second address value to the device if it turns out that this second address value is not assigned to any terminal in the network.

The invention, with its features and advantages, will be made clearer by reading the description of a particular, nonlimiting exemplary embodiment, described with reference to the appended drawings in which:

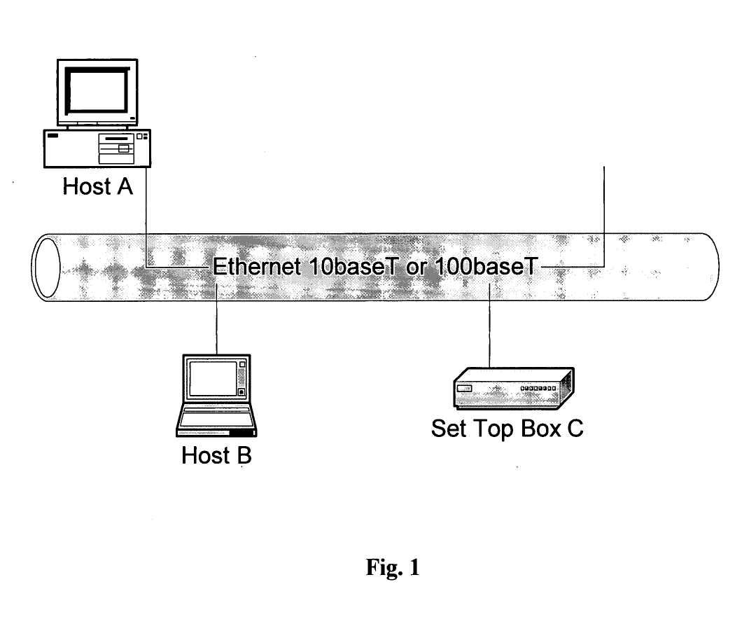

FIG. 1 is a diagram of a network comprising a number of devices according to the embodiment;

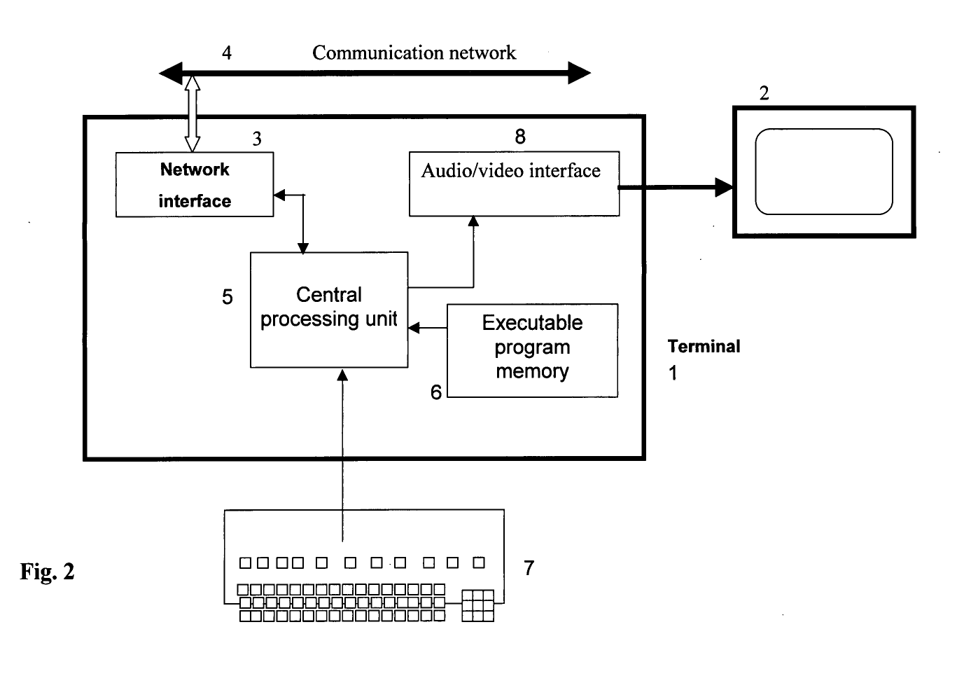

FIG. 2 is a diagram showing the various elements of a terminal using the procedure for generating addresses according to the present embodiment;

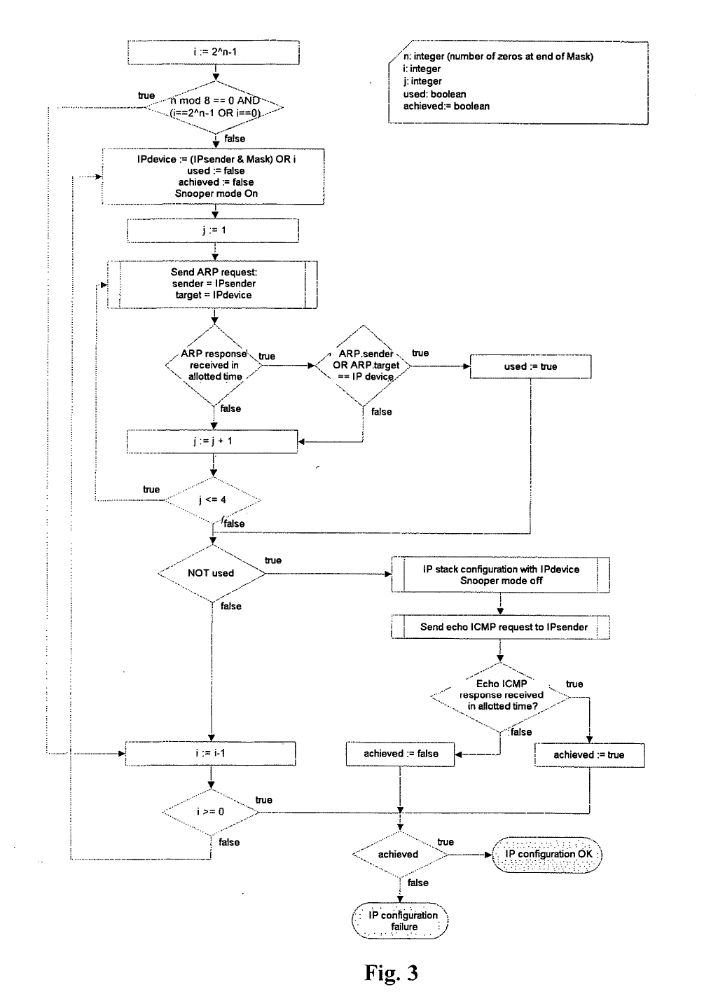

FIG. 3 represents a detailed flow diagram of the procedure for generating addresses according to the present embodiment;

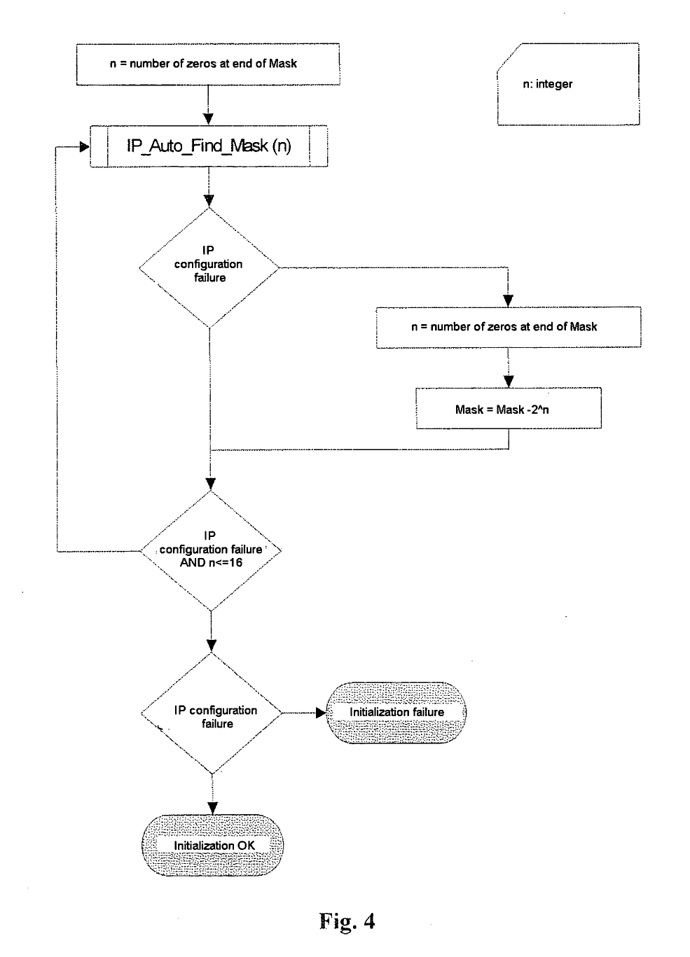

FIG. 4 represents a flow diagram of the procedure for widening the mask in the event of an unsuccessful search for addresses according to the embodiment.

FIG. 1 diagrammatically represents a communication network enabling at least two terminals, “Host A” and “Host B”, to communicate using the IP protocol. Other devices can be connected to this network, such as a digital television Set-Top Box C. The communication channel is set up by an ETHERNET 10 or 100 cable.

We will first of all describe an exemplary device according to a first embodiment of the invention. FIG. 2 shows a multimedia terminal 1 connected to a display device 2 such as a display screen. The receiver 1 is typically a personal computer or an audiovisual terminal equipped with means of communication 3 through a bidirectional network 4. The receiver 1 comprises a central processing unit 5 linked among other things to a memory 6 containing executable programs, a means of sending audiovisual signals to a screen. The terminal is also linked to a keyboard 7. The audiovisual signals are sent to the screen 2 via an audio/video interface 8.

The terminals have an IP address, the format of which depends on the type of network to which they are connected. The IP address is encoded on four bytes. For very large, type A networks, the identifier of the terminal is encoded on three bytes (enabling more than 16 million terminals to be connected) and the identifier of the network is encoded on one byte in which the MSB is equal to 0. For large, type B networks, the identifier of the terminal is encoded on two bytes (enabling more than 64 000 terminals to be connected) and the identifier of the network is encoded on two bytes in which the two most significant bits are “1” and “0”. As for the small, type C networks, the identifier of the terminal is encoded on a single byte (enabling only 254 terminals to be connected, the values 00 and 255 being reserved for another use) and the identifier of the network is encoded on three bytes in which the three most significant bits are respectively “1”, “1” and “0”.

The IP address generation means is typically a program written in the memory 6, but it can also be produced in the form of custom integrated circuits (ASIC or DSP for example). In program form, the means for calculating an address is produced in the form of a module which is preferably stored in the ROM memory of the device. This module can also be downloaded from a medium (diskette or CD-ROM), or even transmitted to the device via a transmission network.

Preferably, the invention is used to calculate address values used in an IP protocol, which does not exclude the invention being applicable to other types of protocols.

After having described the various elements of the terminal according to an embodiment of the invention, we will now explain the different interchanges between the latter and the network, to calculate the address.

It is important first of all to distinguish between two cases:

Case 1: search for an address within an already configured network of at least two devices.

Case 2: search for an address within a network designed to have only two devices, only one of which is currently configured.

Let us look at the first case first.

Initially, the user installs his new device and connects it to the ETHERNET. Then he switches it on. Normally, the device defaults to the “SNOOPER” mode. If not, the user sets it to this state. In this mode of operation, the new device scans all the calls in transit through the network.

Secondly, the user asks a second device already installed and configured within the network to send an ARP request. ARP stands for Address Resolution Protocol, a level 2 protocol used for translation between an IP address and an MAC address and which has the advantage of transmitting existing IP addresses over the network. A simple way of doing this is to send a connection request to another device on the network from this second device. The ARP request, which is in fact the request from the sender to obtain the MAC address of the target computer, has the IP addresses of the sender and the target. The new device captures the ARP request and extracts from it the IP address of the sender of the request and the IP address of the recipient device. In this way, the new device recovers network information, its identifier and therefore its type, A, B, or C, and the address values of the two already configured terminals.

Assuming that the network is type C (MSB configuration “1” “1” “0”), the identifier of the network is encoded on three bytes. Take, for example, the following address values of the device sending the request and the recipient device (in decimal and in binary):

IP address of the sender:

| 192 | 168 | 000 | 009 |
|---|---|---|---|
| 1 1 0 0 0 0 0 0 | 1 0 1 0 1 0 0 0 | 0 0 0 0 0 0 0 0 | 0 0 0 0 1 0 0 1 |

IP address of the recipient:

| 192 | 168 | 000 | 025 |
|---|---|---|---|
| 1 1 0 0 0 0 0 0 | 1 0 1 0 1 0 0 0 | 0 0 0 0 0 0 0 0 | 0 0 0 1 1 0 0 1 |

In the case of a domestic network (normally type C), there is no subnetwork, the IP address of the sender comprises only two fields, the address generator searches for an available address in the network to which it is connected.

For this, the new device compares the bits of the same rank in the two address values received and determines the most significant bit for which the value is different for the sending device and for the receiving device. The field defined from this bit up to the LSB belongs to the address field of the terminal in the subnetwork. In the example, the MSB for which the value is different is the fifth, therefore the five LSBs belong to the address field. The program first of all performs a NOT exclusive OR between the two address values received, and the result according to the present example is

| 192 | 168 | 000 | 009 |
|---|---|---|---|
| 1 1 0 0 0 0 0 0 | 1 0 1 0 1 0 0 0 | 0 0 0 0 0 0 0 0 | 0 0 0 0 1 0 0 1 |

NOT XOR

| 192 | 168 | 000 | 025 |
|---|---|---|---|
| 1 1 0 0 0 0 0 0 | 1 0 1 0 1 0 0 0 | 0 0 0 0 0 0 0 0 | 0 0 0 1 1 0 0 1 |

=====

| 255 | 255 | 255 | 16 |
|---|---|---|---|
| 1 1 1 1 1 1 1 1 | 1 1 1 1 1 1 1 1 | 1 1 1 1 1 1 1 1 | 1 1 1 0 1 1 1 1 |

Then the address generator applies to this result the program for which the pseudo-code is as follows:

```
for i ranging from 30 to 0
    if (bi == 1 AND bi+1 == 0) then
        bi = 0
    end if
end for
```

where bi represents the ith bit of the address in the order from LSB to MSB (b31 is the MSB and b0 the LSB).

The purpose of this program is to search for the first bit from the high order bits for which the value is different for the address 1 and for the address 2. In the event, it is bit 5. The program also calculates the mask to calculate the address by filtering all the bits that form, between the two addresses, a different value, in the event, these are the first five bits, the value for the first address being “01001” and that of the second address is “11001”.

The resulting mask is as follows:

| 255 | 255 | 255 | 224 |
|---|---|---|---|
| 1 1 1 1 1 1 1 1 | 1 1 1 1 1 1 1 1 | 1 1 1 1 1 1 1 1 | 1 1 1 0 0 0 0 0 |

The new device will first of all try to find an available address by varying the value of these five bits in descending order. For this, it will send an ARP request with a first address value and wait for a return. If a terminal responds to its ARP request, this means that this address value is already taken, so it goes on to another address. A variant consists in varying the value of the five bits in ascending order. Another variant consists in randomly generating the value of these five bits.

Advantageously, the changing of the address values sent in the ARP requests to try to find an available value is performed in descending value order, beginning with the maximum value. In practice, conventionally, the users manually configure the address values by beginning with the smallest values and increasing them: 01, 02, 03, etc., in such a way that, if the new device begins testing the highest order values, it has a greater chance of quickly finding an available value, and of minimizing the number of requests for the search for an available address.

In the above example, the first address tested is: 192-168-000-031

Assume that a response is sent to the ARP request; this address value is therefore already taken, the second value tested is:

192-168-000-030

And so on:

192-168-000-029

If after a certain time (this time is fixed by the standard in an RFC, standing for “Request For Comments”, defining the ARP protocol), no response to an ARP request is sent, the new device can consider that the address value tested in the ARP request is available.

If all the IP addresses are taken, the address generation module widens the mask. This part of the module is described in the form of the pseudo-code presented in Appendix 2 and represented in the form of a flow diagram in FIG. 4. The part of the IP address generation module will increase by one bit the size of the field previously determined to contain the address of the terminal. In the above example, the module will consider that the address is on 6 bits, and again test the address values, by setting the sixth bit to 1 and by commencing with the maximum values. The following successive values will be tested:

192-168-000-063.

192-168-000-062.

192-168-000-061 . . . up to: 192-168-000-032

If no address value is available, the module will widen the mask to the seventh bit, and so on until an available address value is found.

Appendix 1 contains a program written in pseudo-code to encode the address search module. FIG. 3 shows a detailed flow diagram corresponding to the program of Appendix 1.

Once an address value has been chosen, it is important to be able to check that the device can communicate with this new address (that the successive widenings have not resulted in an address outside the network of the first captured address). For this, an “ECHO” command of the Internet Control Message Protocol (ICMP) can be used. An “ECHO” command is sent using the IP protocol with a certain quantity of data. When the recipient receives the command, it returns to the sender the same block of data, as an echo. This command is therefore particularly well suited for checking that a new terminal can communicate using the address that has just been assigned to it.

If the “ECHO” command sent by the terminal to be configured does not receive a response within the time defined in RFC 792 (ICMP), then it can be stated that the calculated address cannot be used on the network (probably because the widening of the mask has resulted in an address that is no longer within the same network or subnetwork as the sender of the first request). The procedure can therefore be abandoned with the result that no valid address can be found. A variant for detecting the availability of an address consists in receiving a “Destination not reachable” message (one of the ICMP error messages). This message sent by a network controller indicates that it does not know any terminal having that address.

Appendix 2 contains a program written in pseudo-code to encode the module for widening the mask, used to vary the address value of the terminal within the subnetwork. FIG. 4 shows a detailed flow diagram corresponding to the program in Appendix 2.

Now assume that the network has subnetworks. As was stated in the introduction to the description, before each call, the terminal sending a message must check whether the recipient belongs to the subnetwork. For this test, each terminal has the subnetwork mask, this mask is made up of the concatenation of the network identifier, the subnetwork identifier and the field identifying the terminals with all the bits at “0”. Now let us assume a type B network with the identifier “128”, “168” associated with a subnetwork identifier encoded on seven bits. These are then bits 10 to 16, with bits 1 to 9 defining the address of the terminal in the subnetwork. The subnetwork mask is then:

| 255 | 255 | 254 | 025 |
|---|---|---|---|
| 1 1 1 1 1 1 1 1 | 1 1 1 1 1 1 1 1 | 1 1 1 1 1 1 1 0 | 0 0 0 0 0 0 0 0 |

For the same subnetwork, a logical AND between the mask and an IP address returns the complete identifier of the network and of the subnetwork (hereinafter referred to as network identifier). To determine whether the recipient terminal belongs to the same subnetwork, the sending terminal performs a logical AND between the IP address of the recipient and the subnetwork mask. If this operation returns an identical network identifier to the same operation on its own address, then the recipient is on the same subnetwork as itself and it sends it the message directly. If the two network+subnetwork identifiers differ, then it must send the message to an intermediate server.

The new device wishing to be configured must first of all calculate a minimum mask for calculating the identifier of the network+subnetwork. The first bits define the network type (A, B, or C) and, from this, the size of the network identifier. In the example, the configuration “1”, “0” indicates that the network is type B—identifier “128”, “168”. The size of the subnetwork identifier is unknown. The new device knows that the two devices that have communicated by an “ARP request” are in the same subnetwork, and therefore their IP addresses have the same subnetwork identifier value. This value occupies a certain number of MSB bits of the terminal address value. In the same way as previously, the new device will first of all generate a minimum mask, by calculating the minimum size of the field containing the address value of the terminal in the subnetwork. For this, it determines the varying part between the two addresses received and calculates a mask which filters that part. Then, it tries all the values corresponding to this mask. If one of them is available, the new device takes it and configures itself with it. If no address is available, the new device widens the mask by commencing with the least significant bit at “1” in the mask, this bit changes to “0”. The widening of the mask and the search for an address proceed in the same way as described previously for a network without subnetworks. The advantage of this method is that it definitely tests as a priority all the addresses of the subnetwork. If, after a further widening by one bit, the mask goes beyond the subnetwork, this means that all the addresses of the subnetwork have been tested and none is available. Then, on first testing an address with the new value of the widened mask, the terminal receiving no response will recover this address, but when it wants to check that this address is indeed available by making an ICMP “ECHO” request, it realizes that this address will not enable it to communicate. It then displays a message indicating that the address generator could not find an address.

Now let us look at the solution according to another embodiment relating to the second case.

The network is then limited to two devices. These devices using the standard IP protocol should, as for a type A, B, or C network, have a specific address enabling them to communicate. The solution according to this other embodiment involves the terminal in “Snooper” mode seeing that no terminal is responding to the ARP request, from which it deduces that there is no terminal having this address value and that therefore, it can appropriate that value to configure itself, which means it does not have to calculate a third value.

Initially, a device (the “first”) already has a configured address, the second is in “snooper” mode according to the present embodiment. The difference from the preceding situation is the fact that the first device cannot send a connection request to another device because it is the only one to be configured. The trick consists in asking the user to send on the first device a connection request to a device that does not exist. The device to be configured receives this address, sees that it is available because no device is responding to the request, and decides to assign it to itself. It is therefore much the same procedure as previously, but simplifying it to the maximum; the terminal no longer needs to calculate an address value, it recovers the same value as an address of a terminal which in fact does not exist. To calculate an address compatible with the network easily, the configured terminal sends a second which differs only by the value of a single bit. According to a particularly advantageous refinement, the bit to be changed belongs to the low order byte of the address and more specifically the least significant bit (LSB). In this way, if the address of the first device is even (LSB value equal to “0”), then it sends a request to connect to a device whose address value is the same as its own except for the least significant bit which is forced to “1” (the next immediately higher address). Similarly, if the address is odd (LSB value equal to “1”), then it sends a request to connect to a device whose address value is the same as its own except for the least significant bit which is forced to “0” (the next immediately lower address).

The rest of the procedure proceeds in the same way. The calculated mask can give only two addresses and one of the two is necessarily valid.

The present embodiments should be considered as illustrative but can be modified in the field defined by the scope of the attached claims. In particular, the invention is not limited to television set-top boxes but can be applied to any device for receiving digital audiovisual transmissions: computer, device connected to an IP network, etc.

```
APPENDIX 1
IP_Auto_Find_Mask (IN n :integer)
    var used: boolean
    var achieved: boolean
    var icmp_sent: boolean
    for i from 2ⁿ−1 to 0
        IP_{device} = (IP_{sender} [symbol] Mask) [symbol] i
        used = false
        achieved = false
        icmp_sent = false
        if (n mod 8 == 0 AND (i==0 OR i==2ⁿ−1)) then
            used = true
        else
            for j from 1 to 4
                Send an ARP request (ARP.sender =
                    IP_{sender}, ARP.recipient = IP_{device})
                Wait for ARP response for fixed duration
                if (ARP response received AND (ARP.sender ==
                IP_{device} OR ARP.recipient == IP_{device} ))
                then
                    used = true
                    j = 5
                end if
            end for
        end if
        if (NOT used) then
            Configuration of the IP stack on the device with IP_{device}
            Snooper mode inactive
            Send an ICMP echo request to IP_{sender}
            icmp_sent = true
            Wait for ICMP response for fixed duration or response to
          message indicating “recipient not reached”
            if (ICMP Echo request received) then
                achieved = true
            end if
        end if
        if (icmp_sent) then
            output
        end if
        Snooper mode active
    end for
    if (achieved) then
        IP configuration OK
    else
        IP configuration failure
    end if
```

APPENDIX 2
IP_Setup:

var n : integer
n = (number from “0” to end of Mask)
do

IP_Auto_Find_Mask (n)
if (IP configuration failure) then

n = (number of “0” at end of Mask)
Mask = Mask − 2ⁿ

end if

while (IP configuration failure AND n ≦ 16)
if (IP configuration failure) then

Initialization failure

else

Initialization OK

end if

1. A procedure for generating an address value for a communication terminal linked to a network, the procedure being wherein it comprises the following steps, at terminal level:
a) scanning of messages sent over the network and reception of a message interchanged between two terminals already configured comprising a pair of first and second address values,
b) determination of a characteristic value of the network, said value being contained in the first and the second address values,
c) calculation of a third address value containing the characteristic value of the network,
d) assignment of the third address value to the terminal if this value is not already assigned to another terminal.

2. Procedure for generating an address value as claimed in claim 1, wherein if the terminal deduces from the call captured on the communication network that the second address is available, then the calculation step consists in giving to the third value the value of the second value.

3. The procedure for generating an address value as claimed in claim 1, wherein the third value is calculated by concatenating the characteristic value of the network with a specific value, this specific value being maximum on the first calculation, this specific value being reduced by one unit each time that the preceding third value calculated is found to be assigned to another terminal.

4. The procedure for generating an address value as claimed in claim 3, wherein it comprises a step consisting in changing the value of the least significant bit of the characteristic value of the network, the new characteristic value being reduced by this bit, said step being triggered when all the third values calculated from the preceding characteristic value of the network are already assigned to a terminal.

5. The procedure for generating an address value as claimed in claim 1, wherein the assignment step comprises a step for sending a communication request to a terminal having the third address value, and a step for awaiting reception of a response, the reception of a response signifying that the third address value is not available.

6. The procedure for generating an address value as claimed in claim 1, wherein the assignment step comprises a step for sending a communication request to a terminal having the third address value, and a step for receiving a message sent by the network following said request indicating that the third address value is not assigned to a terminal of the network, the step for receiving such a message triggering the assignment of the third address value to the terminal.

7. An electronic device designed to be connected to a communication network, comprising a means of bidirectional communication with said network, wherein it comprises a means of receiving all the messages sent over the network in order to select a message interchanged between two terminals already configured, said message comprising a first and a second address value, a means for determining a characteristic value of the network which constitutes a part of the first and the second address values, and for calculating a third address value containing the characteristic value of the network, and for assigning this third address value to the device if the reaction following a communication request sent by the communication means to a device having the third address indicates that this third address value is not assigned to any terminal of the network.

8. The electronic device as claimed in claim 7, wherein it comprises a means of sending a communication request to a device having the third address value, and a means of detecting a response to said request, the detection of a response signifying that the third address value is not assigned to a device of the network.

9. The electronic device as claimed in claim 7 wherein the calculation means concatenates the characteristic value of the network previously determined with a specific value, this specific value being at its maximum on a first calculation, the calculation means subtracting one unit from this specific value to calculate a new third address value when it turns out that the preceding calculated address value is already assigned to a terminal.

10. The electronic device as claimed in claim 7, wherein it comprises a means for changing the value of the least significant bit of the characteristic value of the network, the new characteristic value being reduced by this bit, said means being triggered when it turns out that all third values calculated from the preceding characteristic value of the network are already assigned to a terminal.
